(19) United States
(12) Patent Application Publication
(10) Pub. No.: US 2025/0271635 A1
(43) Pub. Date: Aug. 28, 2025

(54) OPTICAL SYSTEM

(71) Applicant: Changzhou AAC Raytech Optronics Co., Ltd., Changzhou City (CN)

(72) Inventor: Siyuan Jiang, Changzhou (CN)

(21) Appl. No.: 18/731,404

(22) Filed: Jun. 3, 2024

(30) Foreign Application Priority Data
Feb. 23, 2024 (CN) 202410202541.6

(51) Int. Cl. G02B 9/12; G02B 5/30; G02B 17/08

(52) U.S. Cl. CPC G02B 9/12; G02B 5/3025; G02B 17/08

(57) ABSTRACT

An optical system is provided, which includes in sequence from a rear side to a front side: an aperture, a first lens, a second lens, a third lens, a circular polarizer, and an image surface. The optical system further satisfies: 5.00≤f2/f≤9.00, 1.30≤(R1+R2)/(R1−R2)≤4.80, 0.90≤R5/R6≤2.80, and SDmax≤23.00 mm. f represents a focal length of the optical system, f2 represents a focal length of the second lens, R1 represents a central curvature radius of a rear side surface of the first lens, R2 represents a central curvature radius of the front side surface of the first lens, R5 represents a central curvature radius of a rear side surface of the third lens, R6 represents a central curvature radius of a front side surface of the third lens; and SDmax represents a maximum effective radius of lenses of the optical system.

### CROSS REFERENCE TO RELATED APPLICATIONS

The present application claims the benefit of priority under the Paris Convention to Chinese Patent Application No. 202410202541.6, filed on Feb. 23, 2024, which is incorporated by reference herein in its entirety.

### TECHNICAL FIELD

The present application relates to the field of near-eye display technology, and in particular to an optical system.

### BACKGROUND

With the rapid development of technology related to a smart headset device in recent years, the application of an electronic device equipped with an optical lens has become more widespread, the requirements for the optical lens have become more diversified, and the applications in the fields of virtual reality, augmented reality, and mixed reality have grown rapidly. From the perspective of user experience, there is an urgent need for an optical system with both a small size and an excellent imaging method.

### SUMMARY

In view of the above problems, an optical system is provided according to the present disclosure, which has good optical performance and meets the design requirements of miniaturization and lightweight.

In view of the above problems, an optical system is provided according to the present disclosure, which includes in sequence from a rear side to a front side: an aperture, located on the rear side of the optical system, a first lens, a second lens, a third lens, a circular polarizer, and an image surface. The circular polarizer is attached to a rear side surface of the image surface, a front side surface of the first lens or a rear side surface of the second lens is provided with a composite film including a reflective polarizing coating and a quarter-wave plate, and the reflective polarizing coating is applied on a rear side of the quarter-wave plate. The optical system further satisfies the following conditions: 5.00≤f2/f≤9.00, 1.30≤(R1+R2)/(R1−R2)≤4.80, 0.90≤R5/R6≤2.80, and SDmax≤23.00 mm. f represents a focal length of the optical system, f2 represents a focal length of the second lens, R1 represents a central curvature radius of a rear side surface of the first lens, R2 represents a central curvature radius of the front side surface of the first lens, R5 represents a central curvature radius of a rear side surface of the third lens, R6 represents a central curvature radius of a front side surface of the third lens; and SDmax represents a maximum effective radius of lenses of the optical system.

As an improvement, the optical system further satisfies the following condition: eyebox≥12 mm, where eyebox represents a size of an eye box of the optical system.

As an improvement, the optical system further satisfies the following condition: eyerelief≤16.50 mm, where eyerelief represents an on-axis distance from a human eye to the rear side surface of the first lens.

As an improvement, the optical system further satisfies the following condition: TL≤18.40 mm, where TL represents an on-axis distance from the rear side surface of the first lens to the image surface.

As an improvement, the optical system further satisfies the following condition: TTL≤34.80 mm, where TTL represents a total track length TTL of the optical system.

As an improvement, the rear side surface and the front side surface of the first lens, the rear side surface and a front side surface of the second lens, and the rear side surface and the front side surface of the third lens are aspherical.

As an improvement, the optical system further satisfies the following condition: 85.00°≤FOV≤95.00°, where FOV represents a field of view of the optical system.

As an improvement, a front side surface of the second lens is coated with a semi-transparent and semi-reflective film.

As an improvement, each of a transmittance and a reflectivity of the semi-transparent and semi-reflective film ranges from 40% to 60%.

As an improvement, a transmittance of the reflective polarizing coating is greater than or equal to 95%.

As an improvement, the optical system further satisfies the following condition: MIST≤35.00%, where MIST represents a distortion of the optical system.

As an improvement, the optical system further satisfies the following condition: LC≤100 μm, where LC represents a lateral color of the optical system.

As an improvement, the optical system further satisfies the following condition: TTL/f≤2.10, where TTL represents a total track length of the optical system.

As an improvement, the image surface is a display with a size ranging from 1.0 inch to 1.3 inches.

The present disclosure has the following beneficial effects: the composite film including the reflective polarizing coating and the quarter-wave plate is arranged on the front side surface of the first lens or the rear side surface of the second lens, and the semi-transparent and semi-reflective film is arranged on the front side surface of the second lens, so that an optical path folding structure is realized through the participation of two lenses, and the total track length TTL of the optical system is greatly reduced, thereby reducing a volume of an optical imaging module and meeting the design requirements of miniaturization and lightweight of a VR device. In addition, the optical system according to the present disclosure enables a user to obtain the best display effect without complicated adjustment, with both small volume and high imaging performance.

### BRIEF DESCRIPTION OF THE DRAWINGS

In order for a clearer illustration of technical solutions in embodiments of the present disclosure or the conventional technology, drawings used in the description of the embodiments or the conventional technology are described briefly hereinafter. Apparently, the drawings described in the following illustrate some embodiments of the present disclosure, other drawings may be obtained by those ordinarily skilled in the art based on these drawings without any creative effort.

FIG. 1 is a schematic structural diagram of an optical system according to a first embodiment of the present disclosure;

FIG. 2 is a schematic diagram of a dot column of the optical system shown in FIG. 1;

FIG. 3 is a schematic diagram of a lateral color of the optical system shown in FIG. 1;

FIG. 4 is a schematic diagram of a field curvature and a distortion of the optical system shown in FIG. 1;

FIG. 5 is a schematic diagram of the optical system including a film structure shown in FIG. 1;

FIG. 6 is a partially schematic structural diagram of an optical system according to a second embodiment of the present disclosure;

FIG. 7 is a schematic diagram of a dot column of a camera optical lens shown in FIG. 6.

FIG. 8 is a schematic diagram of a lateral color of the camera optical lens shown in FIG. 6;

FIG. 9 is a schematic diagram of a field curvature and a distortion of the camera optical lens shown in FIG. 6; and

FIG. 10 is a schematic diagram of the optical system including a film structure shown in FIG. 6.

### DETAILED DESCRIPTION OF THE EMBODIMENTS

In order to make the purpose, technical solutions and advantages of the present disclosure clear, the embodiments of the present disclosure are described in detail in conjunction with the drawings. However, it can be understood by those skilled in the art that in the embodiments of the present disclosure, many technical details are proposed to enable the reader to better understand the present disclosure. However, even without these technical details and various changes and modifications based on the following embodiments, the technical solutions claimed by the present disclosure can be realized.

The technical solutions in the embodiments of the present disclosure are described clearly and completely in conjunction with the drawings of the embodiments of the disclosure hereinafter. It is apparent that the described embodiments are only some rather than all embodiments of the present disclosure. Any other embodiments obtained by those skilled in the art based on the embodiments in the present disclosure without any creative effort shall fall within the protection scope of the present disclosure.

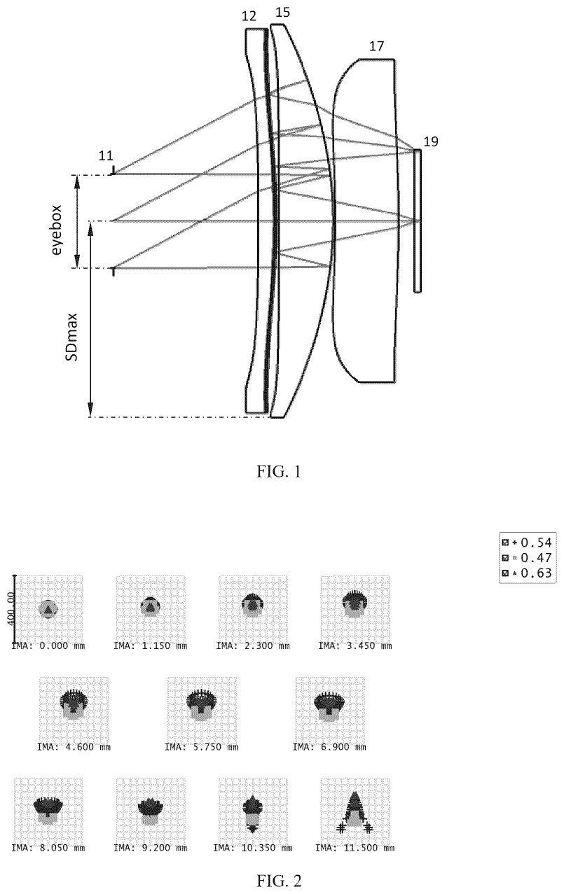

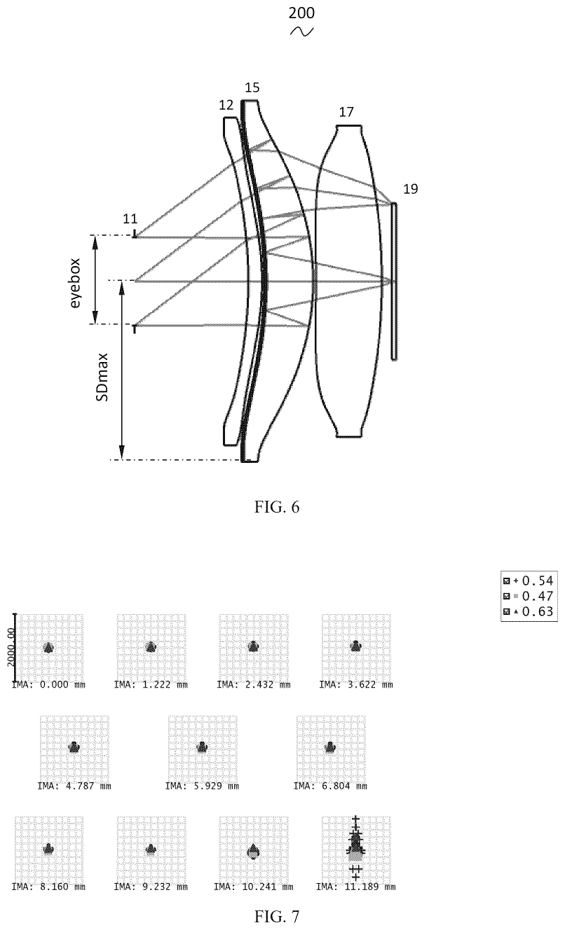

Referring to FIG. 1 to FIG. 10, an optical system 100 shown in FIG. 1 and an optical system 200 shown in FIG. 6 are provided according to the technical solutions of the present disclosure. The optical systems 100, 200 each include three lenses. Specifically, the optical systems 100, 200 each include in sequence from a rear side to a front side: an aperture 11, a first lens 12, a reflective polarizing coating 13, a quarter-wave plate 14, a second lens 15, a semi-transparent and semi-reflective film 16, a third lens 17, a circular polarizer 18, and an image surface 19. According to the present disclosure, the image surface 19 is a display with a size ranging from 1.0 inch to 1.3 inches. It should be noted that according to the present disclosure, the rear side is a human eye side and the front side is a display side, the front side surface refers to a surface facing the display side in an optical axis direction, and the rear side refers to a surface facing the human eye side in the optical axis direction.

Specifically, the light emitted from the image surface 19 passes through the circular polarization 18 to form left-handed circularly polarized light LCP incident on the third lens 17. A front side surface of the second lens 15 is coated with the semi-transparent and semi-reflective film 16. The left-handed circularly polarized light LCP emitted from a rear side surface of the third lens 17 is incident on the semi-transparent and semi-reflective film 16, and part of the light is reflected and part of the light is incident on the second lens 15. In this case, the light incident on the second lens 15 is the left-handed circularly polarized light LCP.

When a front side surface of the first lens 12 is provided with a composite film including the reflective polarizing coating 13 and the quarter-wave plate 14, the reflective polarizing coating 13 is closer to the front side surface of the first lens 12 than the quarter-wave plate 14. Left-handed circularly polarized light LCP emitted from the second lens 15 passes through the quarter-wave plate 14 for the first time and is converted into linearly polarized S-light. The linearly polarized S-light is subsequently reflected at the reflective polarizing coating 13. In this case, the reflected light is still the linearly polarized S-light. After passing through the quarter-wave plate 14 for the second time, the linearly polarized S-light is converted into the left-handed circularly polarized light LCP incident on the second lens 15 for the second time, part of the left-handed circularly polarized light LCP is reflected at the semi-transparent and semi-reflective film 16, and the reflected light is converted into right-handed circularly polarized light RCP incident on the second lens 15 for the third time. The right-handed circularly polarized light RCP emitted from the second lens 15 is incident on the quarter-wave plate 14, is converted into the linearly polarized P-light after passing through the quarter-wave plate 14, and is incident on the reflective polarizing coating 13. Since the reflective polarizing coating 13 has the characteristics of reflecting the linearly polarized S-light and transmitting the linearly polarized P-light, the linearly polarized P-light is transmitted to the first lens 12 and is incident on the aperture 11. A position of the aperture 11 is a position simulating a surface of a human eye.

When a rear side surface of the second lens 15 is provided with a composite film including the reflective polarizing coating 13 and the quarter-wave plate 14, the reflective polarizing coating 13 is further away from the rear side surface of the second lens 15 than the quarter-wave plate 14, Left-handed circularly polarized light LCP emitted from the second lens 15 passes through the quarter-wave plate 14 for the first time and is converted into linearly polarized S-light, and is subsequently reflected at the reflective polarizing coating 13. In this case, the reflected light is still the linearly polarized S-light. After passing through the quarter-wave plate 14 for the second time, the linearly polarized S-light is converted into the left-handed circularly polarized light LCP incident on the second lens 15 for the second time, part of the left-handed circularly polarized light LCP is reflected at the semi-transparent and semi-reflective film 16, and the reflected light is converted into right-handed circularly polarized light RCP incident on the second lens 15 for the third time. The right-handed circularly polarized light RCP emitted from the second lens 15 is incident on the quarter-wave plate 14, is converted into the linearly polarized P-light after passing through the quarter-wave plate 14, and is incident on the reflective polarizing coating 13. Since the reflective polarizing coating 13 has the characteristics of reflecting the linearly polarized S-light and transmitting the linearly polarized P-light, the linearly polarized P-light is transmitted to the first lens 12 and is incident on the aperture 11.

The front side surface of the first lens 12 is provided with the composite film including the reflective polarizing coating 13 and the quarter-wave plate 14, and an optical path folding structure is used, which reduces the volume of the optical system. The semi-transparent and semi-reflective film 16 is arranged on the front side surface of the second lens 15, and the first lens 12 and the second lens 15 are used to participate in the folding scheme of the optical path scheme, which greatly reduces the total track length of the optical system and is beneficial to the development trend of miniaturization and lightweight of a VR device.

A focal length of the optical system is defined as f, and a focal length of the second lens 15 is defined as f2. The optical system further satisfies the following condition: 5.00≤f2/f≤9.00. A ratio of the focal length of the second lens 15 to the total focal length of the optical system is specified. Within the range of the condition, the off-axis aberration of the field of view can be corrected by the distribution of the focal length.

A central curvature radius of the rear side surface of the first lens 12 is defined as R1, and a central curvature radius of the front side surface of the first lens 12 is defined as R2. The optical system further satisfies the following condition: 1.30≤(R1+R2)/(R1−R2)≤4.80. A shape of the first lens is specified. Within the range of the condition, it is beneficial to correcting the aberration of light during reflection by reasonably controlling the surface type, and is beneficial to shortening the total track length of the optical system.

A central curvature radius of the rear side surface of the third lens 17 is defined as R5, and a central curvature radius of the front side surface of the third lens 17 is defined as R6. The optical system further satisfies the following condition: 0.90≤R5/R6≤2.80. Within the range of the condition, an angle of light emitting from the third lens 17 can be effectively increased by controlling the surface type of the third lens 17 on a screen side, so that the optical system has a large field of view, thereby providing a large eye movement range.

A maximum effective radius of lenses in optical system is defined as SDmax. The optical system further satisfies the following condition: SDmax≤23.00 mm, thereby being beneficial to reducing a volume of the optical system within the range of the condition.

A size of an eye box of the optical system is defined as eyebox. The optical system further satisfies the following condition: eyebox≥12 mm. Within the range of the condition, a user can see the best display effect at the best position without complicated adjustment, the FOV is increased, and the FOV can reach 90°. For further understanding, the size eyebox of the eye box is referred to as a sum of an entrance pupil diameter ENPD±4 mm and an eye movement range eyeshift±4 mm of the optical system. By setting the condition that eyebox≥12 mm, the performance of the full field of view of the optical system is better, and the display experience of the users caused by poor adjustment of the glass position is improved.

An on-axis distance from the human eye to the rear side surface of the first lens 12 is defined as eyerelief, that is, an on-axis distance from the aperture 11 to the rear side surface of the first lens 12 is defined as eyerelief, which is a space where other structure (such as a mechanical mechanism, a glass, etc.) can be placed. The optical system further satisfies the following condition: eyerelief≤16.50 mm. Within the range of the condition, the total track length of the optical system is smaller under the condition of meeting the eye smoothness, which is beneficial to miniaturization.

An on-axis distance from the rear side surface of the first lens 12 to the image surface 19 is defined as TL. The optical system further satisfies the following condition: TL≤18.40 mm, thereby being beneficial to the miniaturization of the optical system within the range of the condition.

A total track length of the optical system is defined as TTL, which is an on-axis distance from the human eye to the image surface 19, that is, an on-axis distance from the aperture 11 to the image surface 19. The optical system further satisfies the following condition: TTL≤34.80 mm, thereby being beneficial to the miniaturization of the optical system within the range of the condition.

The rear side surface and the front side surface of the first lens 12, the rear side surface and the front side surface of the second lens 15, and the rear side surface and the front side surface of the third lens 17 are aspherical. By adjusting the focus position of the displayed image with the design of aspheric surface, the lateral color and the distortion of the displayed image are reduced and the imaging quality is improved.

According to the present disclosure, each of a transmittance and a reflectivity of the semi-transparent and semi-reflective film 16 ranges from 40.00% to 60.00%. For example, in various embodiments, a ratio from the transmittance to the reflectivity may be 50:50, 40:60, 60:40, etc.

According to the present disclosure, a transmittance of the reflective polarizing coating 13 is greater than or equal to 95%, and the high transmittance improves the light efficiency of the optical system and increases the display brightness.

A distortion of the optical system is defined as MIST. The optical system further satisfies the following condition: MIST≤35.00%. Within the range of the condition, the distortion of the optical system is relatively small, which provides the user with a more realistic VR device.

A lateral color of the optical system is defined as LC. The optical system further satisfies the following condition: LC≤100 μm. Within the range of the condition, the lateral color of the optical system is small, which provides the user with a more realistic device.

A focal length of the optical system is defined as f. The optical system further satisfies the following condition: TTL/f≤2.10, thereby being beneficial to reducing a volume of the optical system within the range of the condition.

### First Embodiment

The optical system 100 according to the present disclosure will be described with an example. The symbols recorded in each example are as follows. The units of the focal length, the on-axis distance, the central curvature radius, the on-axis thickness, the inflexion points and the arrest point are mm.

The optical system 100 according to a first embodiment of the present disclosure is shown in FIG. 1 to FIG. 5.

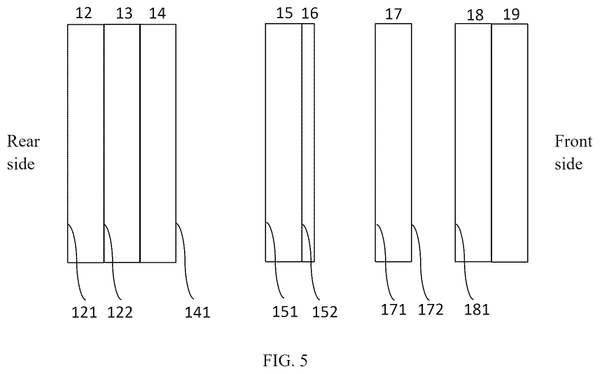

As shown in FIG. 5, in the first embodiment, the composite film including the reflective polarizing coating 13 and the quarter-wave plate 14 is arranged on the front side surface 122 of the first lens 12.

Tables 1 and 2 show the design data of the optical system 100 according to the first embodiment of the present disclosure.

TABLE 1

| | R | d | | nd | | νd | |
|---|---|---|---|---|---|---|---|
| OBJECT | ∞ | | −1437.5 | | | | |
| Aperture | ∞ | d0 | 16.400 | | | | |
| R1 | −528.090 | d1 | 1.748 | n1 | 1.658 | v1 | 21.00 |
| R2 | −83.460 | d2 | 0.166 | | 1.492 | | 57.44 |
| R2 | −83.460 | d3 | 0.122 | | 1.492 | | 57.44 |
| R2 | −83.460 | d4 | 0.289 | | | | |
| R3 | −1395.925 | d5 | 6.098 | n2 | 1.544 | v2 | 56.11 |
| R4 | −46.238 | d6 | −6.098 | | | | |
| R3 | −1395.925 | d7 | −0.289 | | | | |
| R2 | −83.460 | d8 | −0.122 | | 1.492 | | 57.44 |
| R2 | −83.460 | d3 | 0.122 | | | | |
| R2 | −83.460 | d4 | 0.289 | | | | |
| R3 | −1395.925 | d5 | 6.098 | n2 | 1.544 | v2 | 56.11 |
| R4 | −46.238 | d9 | 0.248 | | | | |
| R5 | −141.445 | d10 | 7.155 | n3 | 1.544 | v3 | 56.11 |
| R6 | −151.139 | d11 | 1.811 | | | | |
| Circular | | d12 | 0.671 | ng | 1.517 | vg | 64.17 |
| polarizer | | | | | | | |
| Image | | | | | | | |
| surface | | | | | | | |

The meanings of various symbols are described as follows:
R: curvature radius at a center of an optical surface;
R1: central curvature radius of the rear side surface of the first lens 18;
R2: central curvature radius of the front side surface of the first lens 18;
R3: central curvature radius of the rear side surface of the second lens 15;
R4: central curvature radius of the front side surface of the second lens 15;
R5: central curvature radius of the rear side surface of the third lens 14;
R6: central curvature radius of the front side surface of the third lens 14;
d: on-axis thickness of the lens, and an on-axis distance between the lenses (in order to understand the optical path easily, the value with the light propagating from the rear side to the front side is set as a positive value, and the value with the light from the front side to the rear side is set as a negative value);
d0: The on-axis distance from the aperture 11 to the rear side surface 121 of the first lens 12;
d1: on-axis thickness of the first lens 12;
d2: on-axis thickness of the reflective polarizing coating 13;
d3: on-axis thickness of the quarter-wave plate 14;
d4: on-axis distance from the front side surface 141 of the quarter wave film 14 to the rear side surface 151 of the second lens 15;
d5: on-axis thickness of the second lens 15;
d6: negative value of the on-axis thickness of the second lens 15;
d7: negative value of the on-axis distance from the front side surface 141 of the quarter wave plate 14 to the rear side surface 151 of the second lens 15;
d8: negative value of the on-axis thickness of the quarter wave plate 14;
d9: on-axis distance of the front side surface 152 of the second lens 15 to the rear side surface 171 of the third lens 17;
d10: on-axis thickness of the third lens 17;
d11: on-axis distance from the front side surface 172 of the third lens 17 to the rear side surface 181 of the circular polarizer 18;
d12: on-axis thickness of the circular polarizer 18;
nd: refractive index of the d line (the d line is green light with a wavelength of 540 nm);
nd1: refractive index of the d line of the first lens 12;
nd2: refractive index of the d line of the second lens 15;
nd3: refractive index of the d line of the third lens 17;
ng: refractive index of the d line of the circular polarizer 18;
vd: Abbe number;
v1: Abbe number of the first lens 12;
v2: Abbe number of the second lens 15;
v3: Abbe number of the third lens 17;
vg: Abbe number of the circular polarizer 18.

Table 2 shows the data of the aspherical surface of each lens in the optical system 100 according to the first embodiment of the present disclosure.

TABLE 2

| | Conic | | | | |
|---|---|---|---|---|---|
| | coefficient | Aspheric surface coefficients | | | |
| | k | A4 | A6 | A8 | A10 |
| R1 | 1.25E+01 | −5.52E−06 | 2.52E−09 | 2.63E−12 | −3.55E−14 |
| R2 | −5.42E+01 | 2.55E−06 | 2.03E−09 | 1.41E−12 | −1.79E−16 |
| R3 | −9.90E+01 | 8.27E−08 | −2.72E−09 | −1.79E−12 | −2.61E−15 |
| R4 | −1.24E+00 | 4.49E−07 | −2.87E−11 | 2.37E−12 | 1.26E−15 |
| R5 | 5.19E+01 | 7.41E−06 | 4.93E−08 | 2.95E−11 | 5.78E−14 |
| R6 | −6.03E+01 | 4.05E−06 | 5.17E−09 | 1.23E−12 | −7.01E−14 |

| | Conic | | | |
|---|---|---|---|---|
| | coefficient | Aspheric surface coefficients | | |
| | k | A12 | A14 | A16 |
| R1 | 1.25E+01 | −2.00E−16 | −3.00E−19 | 1.82E−21 |
| R2 | −5.42E+01 | −3.73E−18 | −4.20E−21 | −1.15E−23 |
| R3 | −9.90E+01 | −3.03E−18 | −1.24E−20 | −1.57E−23 |
| R4 | −1.24E+00 | −2.42E−18 | −6.26E−21 | −2.73E−23 |
| R5 | 5.19E+01 | −5.07E−17 | 5.40E−19 | 1.58E−21 |
| R6 | −6.03E+01 | −2.85E−16 | −5.83E−19 | 5.29E−21 |

For convenience, the aspherical surfaces of each lens surfaces use the aspherical surfaces shown in formula (1) below. However, the present disclosure is not limited to the polynomial form of the aspherical surface expressed in this formula (1).

$$z = ( c {r}^{2} ) / \{ 1 + {[ 1 ( k + 1 ) ( {c}^{2} {r}^{2} ) ]}^{1 / 2} \} + A 4 {r}^{4} + A 6 {r}^{6} + A8 {r}^{8} + A 10 {r}^{10} + A 12 {r}^{12} + A 14 {r}^{14} + A 16 {r}^{16} \qquad ( 1 )$$

k represents the conic coefficient, A4, A6, A8, A10, A12, A14 and A16 represent the aspheric surface coefficients, C represents the curvature radius at the center of the optical surface, R represent a vertical distance between the point on the aspheric curve and the optical axis, and Z represent an aspheric depth (a vertical distance between the point on the aspheric surface at a distance of r from the optical axis and the tangent plane tangent to the vertex on the optical axis of the aspheric surface).

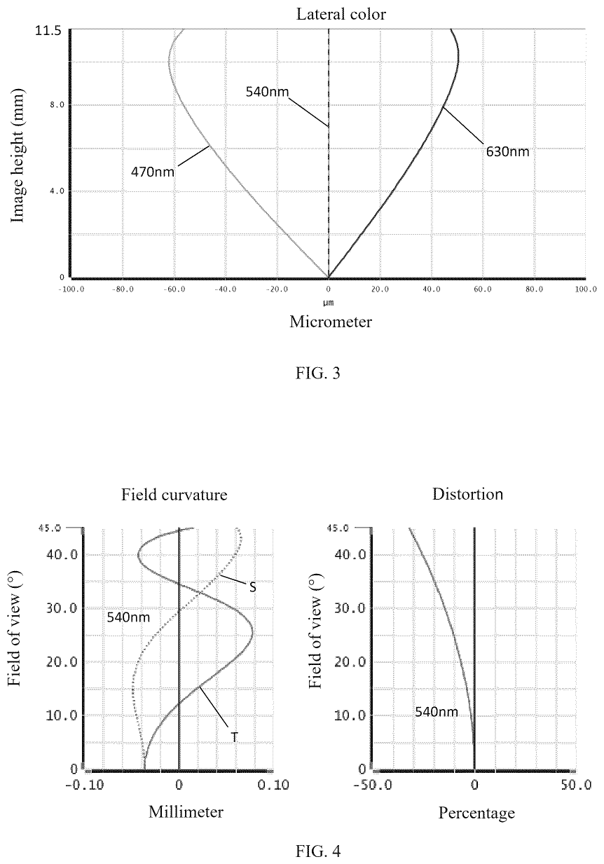

FIG. 2 and FIG. 3 illustrate a diagram of a dot column and a diagram of a lateral color of light with wavelengths of 470 nm, 540 nm and 630 nm after passing through the optical system 100 according to the first embodiment, respectively. FIG. 4 illustrates a schematic diagram of a field curvature and a distortion of light with a wavelength of 540 nm after passing through the optical system 100 according to the first embodiment. A field curvature S in FIG. 4 is a field curvature in a sagittal direction, and T is a field curvature in a meridian direction.

In this embodiment, an entrance pupil diameter ENPD of the optical system 100 is 4.00 mm, an image height IH of 1.0H is 11.500 mm, and a field of view FOV in a diagonal direction is 89.94°. Thus, the optical system 100 meets the design requirements of miniaturization and lightweight, and the on-axis chromatic aberration and the off-axis aberration are fully corrected, thereby achieving excellent optical characteristics.

### Second Embodiment

The second embodiment is substantially the same as the first embodiment, the symbols have the same meaning as the first embodiment, and only the differences are listed below.

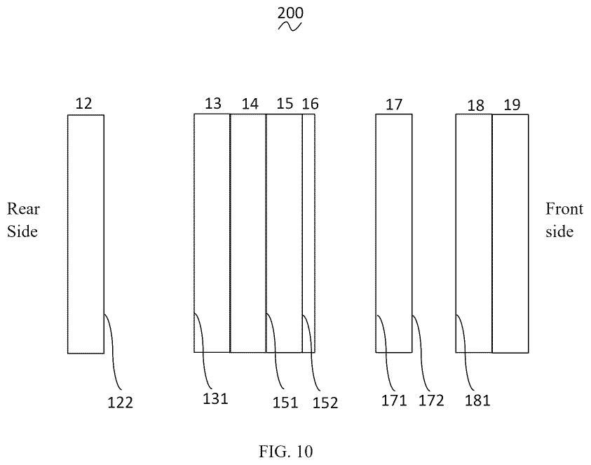

An optical system 200 according to a second embodiment of the present disclosure is shown in FIG. 6 and FIG. 10.

As shown in FIG. 10, in the optical system 200 according to the second embodiment, the composite film including reflective polarizing coating 13 and the quarter-wave plate 14 is arranged on the rear side surface 151 of the second lens 15.

Table 3 and table 4 show the design data of the optical system 200 according to the second embodiment of the present disclosure.

Since the arrangement position of the composite film in the second embodiment is different from the arrangement position of the composite film in the first embodiment, unlike the first embodiment, d4 in Table 3 represents: the on-axis distance from the front side surface 122 of the first lens 12 to the rear side surface 131 of the reflective polarizing coating 13.

TABLE 3

| | R | d | | nd | | νd | |
|---|---|---|---|---|---|---|---|
| OBJECT | ∞ | | −1342.8 | | | | |
| Aperture | ∞ | d0 | 13.800 | | | | |
| R1 | −50.139 | d1 | 1.671 | n1 | 1.658 | v1 | 21.00 |
| R2 | −32.608 | d4 | 0.249 | | | | |
| R2 | −49.194 | d2 + d3 | 0.300 | | 1.492 | | 57.44 |
| R2 | −49.194 | d5 | 5.647 | n2 | 1.544 | v2 | 56.11 |
| R3 | −30.903 | d6 | −5.647 | | | | |
| R4 | −49.194 | d8 | −0.127 | | 1.492 | | 57.44 |
| R3 | −49.194 | d3 | 0.127 | | | | |
| R2 | −49.194 | d5 | 5.647 | n2 | 1.544 | v2 | 56.11 |
| R2 | −30.903 | d9 | 0.350 | | | | |
| R2 | −216.350 | d10 | 8.009 | n3 | 1.658 | v3 | 21.00 |
| R3 | −79.264 | d11 | 1.200 | | | | |
| Circular | | d12 | 0.550 | ng | 1.517 | vg | 64.21 |
| polarizer | | | | | | | |
| Image | | | | | | | |
| surface | | | | | | | |

Table 4 shows the data of the aspherical surface of each lens in the optical system 200 according to the second embodiment of the present disclosure.

TABLE 4

| | Conic | | | | |
|---|---|---|---|---|---|
| | coefficient | Aspheric surface coefficient | | | |
| | k | A4 | A6 | A8 | A10 |
| R1 | −2.97E+01 | −6.25E−06 | −1.78E−08 | 7.50E−11 | −7.25E−14 |
| R2 | −1.02E+01 | 2.91E−06 | 2.62E−08 | −2.93E−11 | 1.09E−13 |
| R3 | −4.32E+00 | 7.16E−07 | 3.84E−09 | 1.20E−11 | 4.76E−14 |
| R4 | 1.67E−01 | 1.22E−06 | 5.60E−09 | 7.78E−12 | 1.44E−14 |
| R5 | 8.29E+01 | 3.19E−05 | −5.12E−08 | 1.54E−10 | 2.63E−13 |
| R6 | −7.12E−01 | −1.38E−05 | 5.60E−08 | 1.37E−10 | −4.13E−13 |

| | Conic | | | |
|---|---|---|---|---|
| | coefficient | Aspheric surface coefficients | | |
| | k | A12 | A14 | A16 |
| R1 | −2.97E+01 | −3.48E−16 | −1.01E−17 | 3.28E−20 |
| R2 | −1.02E+01 | −1.09E−16 | −1.26E−18 | 1.23E−21 |
| R3 | −4.32E+00 | −4.45E−17 | 2.02E−20 | −1.70E−22 |
| R4 | 1.67E−01 | 3.99E−17 | 2.03E−19 | −2.05E−22 |
| R5 | 8.29E+01 | 7.01E−16 | −2.12E−20 | −1.38E−20 |
| R6 | −7.12E−01 | −3.02E−15 | 6.18E−18 | 2.13E−21 |

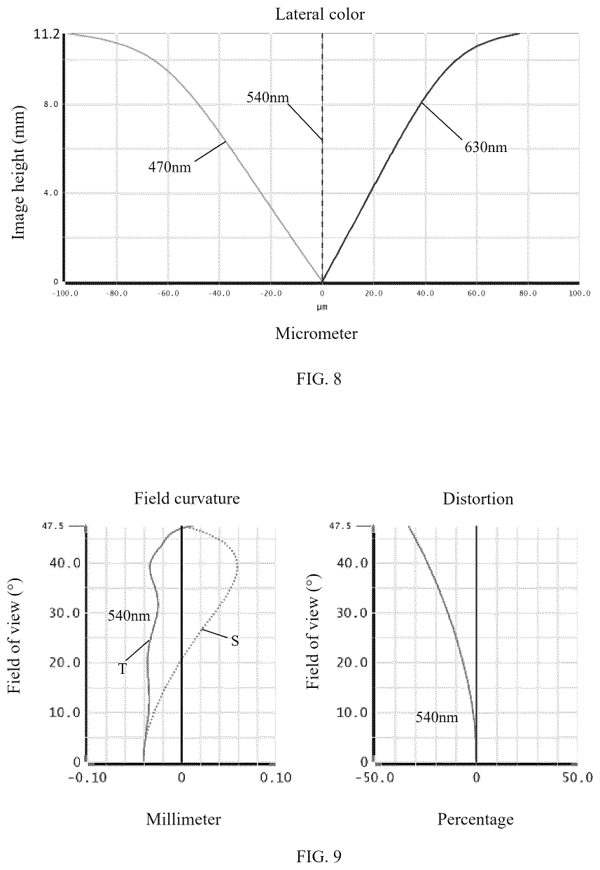

FIG. 7 and FIG. 8 illustrate a diagram of a dot column and a diagram of a lateral color of light with wavelengths of 470 nm, 540 nm and 630 nm after passing through the optical system 200 according to the second embodiment, respectively. FIG. 9 is a schematic diagram of a field curvature and a distortion of light with a wavelength of 540 nm after passing through the optical system 200 according to the second embodiment. A field curvature S in FIG. 9 is a field curvature in a sagittal direction, and T is a field curvature in a meridian direction.

In this embodiment, an entrance pupil diameter ENPD of the optical system 100 is 4.00 mm, an image height IH of 1.0H is 11.200 mm, and a field of view FOV in a diagonal direction is 94.95°. Thus, the optical system 200 meets the design requirements of miniaturization and lightweight, and the on-axis aberration and the off-axis aberration are fully corrected, thereby achieving excellent optical characteristics.

TABLE 5

| Parameters and | First | Second |
|---|---|---|
| Conditional Equations | Embodiment | Embodiment |
| f2/f | 5.19 | 8.93 |
| (R1 + R2)/(R1 − R2) | 1.38 | 4.72 |
| R5/R6 | 0.94 | 2.73 |
| SDmax | 23.00 | 22.00 |
| eyebox | 12.00 | 12.00 |
| TL | 18.307 | 17.977 |
| TTL | 34.707 | 31.777 |
| IH | 11.500 | 11.200 |
| FOV | 89.94 | 94.95 |

It can be understood by those skilled in the art that the above embodiments are specific embodiments for realizing the present disclosure. However, in practical application, various changes can be made in form and detail without departing from the spirit and scope of the present disclosure.

What is claimed is:

1. An optical system, comprising in sequence from a rear side to a front side:
an aperture, located on the rear side of the optical system;
a first lens;
a second lens;
a third lens;
a circular polarizer; and
an image surface;
wherein the circular polarizer is attached to a rear side surface of the image surface, a front side surface of the first lens or a rear side surface of the second lens is provided with a composite film including a reflective polarizing coating and a quarter-wave plate, and the reflective polarizing coating is applied on a rear side of the quarter-wave plate;
wherein the optical system satisfies the following conditions:
$$\begin{matrix}5. \leq f 2 / f \leq 9 \text{.00} ; \\ 1.3 \leq ( R 1 + R 2 ) / ( R 1 R 2 ) \leq 4 \text{.80} ; \\ 0.9 \leq R 5 / R 6 \leq 2.8 ; and \\ SD max \leq 23. mm .\end{matrix}$$
wherein f represents a focal length of the optical system;
f2 represents a focal length of the second lens;
R1 represents a central curvature radius of a rear side surface of the first lens;
R2 represents a central curvature radius of the front side surface of the first lens;
R5 represents a central curvature radius of a rear side surface of the third lens;
R6 represents a central curvature radius of a front side surface of the third lens; and
SDmax represents a maximum effective radius of lenses of the optical system.

2. The optical system of claim 1, wherein the optical system further satisfies the following condition:
eyebox≥12 mm;
wherein eyebox represents a size of an eye box of the optical system.

3. The optical system of claim 1, wherein the optical system further satisfies the following condition:
eyerelief≤16.50 mm;
wherein eyerelief represents an on-axis distance from a human eye to the rear side surface of the first lens.

4. The optical system of claim 1, wherein the optical system further satisfies the following condition:
TL≤18.40 mm;
wherein TL represents an on-axis distance from the rear side surface of the first lens to the image surface.

5. The optical system of claim 1, wherein the optical system further satisfies the following condition:
TTL≤34.80 mm;
wherein TTL represents a total track length TTL of the optical system.

6. The optical system of claim 1, wherein the rear side surface and the front side surface of the first lens, the rear side surface and a front side surface of the second lens, and the rear side surface and the front side surface of the third lens are aspherical.

7. The optical system of claim 1, wherein the optical system further satisfies the following condition:
85.00°≤FOV≤95.00°;
wherein FOV represents a field of view of the optical system.

8. The optical system of claim 1, wherein a front side surface of the second lens is coated with a semi-transparent and semi-reflective film.

9. The optical system of claim 8, wherein each of a transmittance and a reflectivity of the semi-transparent and semi-reflective film ranges from 40% to 60%.

10. The optical system of claim 1, wherein a transmittance of the reflective polarizing coating is greater than or equal to 95%.

11. The optical system of claim 1, wherein the optical system further satisfies the following condition:
MIST≤35.00%;
wherein MIST represents a distortion of the optical system.

12. The optical system of claim 1, wherein the optical system further satisfies the following condition:
LC≤100 μm;
wherein LC represents a lateral color of the optical system.

13. The optical system of claim 1, wherein the optical system further satisfies the following condition:
$$TTL / f \leq 2 \text{.10} ;$$
wherein TTL represents a total track length of the optical system.

14. The optical system of claim 1, wherein the image surface is a display with a size ranging from 1.0 inch to 1.3 inches.
